(19) United States
(12) Patent Application Publication
(10) Pub. No.: US 2019/0333063 A1
(43) Pub. Date: Oct. 31, 2019

(54) SYSTEMS AND METHODS FOR PROVIDING INTERACTIONS BETWEEN USERS AND TRANSPORTATION SERVICE PROVIDERS IN AN INTEGRATED PUBLIC AND/OR PRIVATE TRANSPORTATION SERVICE PLATFORM

(71) Applicant: MANJALINK PTE LTD, Singapore (SG)

(72) Inventor: Chern Chuen LIM, Singapore (SG)

(21) Appl. No.: 16/309,819

(22) PCT Filed: Jun. 15, 2017
(86) PCT No.: PCT/IB2017/000734

§ 371 Date: Dec. 13, 2018

Related U.S. Application Data
(60) Provisional application No. 62/350,578, filed on Jun. 15, 2016.

(51) Int. Cl. G06Q 20/40; G06Q 20/42; G06Q 20/32; G06Q 20/04; G06Q 20/36; G06Q 50/30; G08G 1/00

(52) U.S. Cl. CPC G06Q 20/401; G06Q 20/42; G06Q 20/3224; G08G 1/20; G06Q 20/367; G06Q 50/30; G06Q 20/0457

(57) ABSTRACT

Systems and methods for providing fare payment on fleet vehicles using user devices are disclosed. A system for providing fare payment may include a processing system on the fleet vehicle, a user device and a transportation services platform that communicate via a network. The processing device receives fare payment information from a user device and fare verification information from the transportation services platform. The processing system in the fleet vehicle then verifies that fare payment information and sends confirmation to the user device and/or the transportation services platform. In addition, the systems and methods may also provide a destination indication system that is accessed by the user device and/or equipment for manual indication that a destination is reached.

### FIELD OF THE INVENTION

This invention relates to provision of an integrated public and private transportation services platform to provide transportation service over the Internet. More particularly, this invention relates to the provision of interactive communications between a user and a service provider operator during a trip.

### BACKGROUND OF THE INVENTION

In today's society, there are plenty of software applications, commonly called Apps, provided for smart phones or other mobile devices for use in the planning and managing of trips between various destinations. Some of these applications allow interaction between the user and one or more transit operators that operates a fleet of transportation vehicles.

Currently, many of these transit operators maintain various separate systems to manage operations associated with providing transportation services to users. For example, a transit operator that maintains a fleet of buses may maintain one system for interacting with users, a second system for tracking vehicles within the operator's fleet, a third system for managing payments by users, and a fourth system that allows communication between a driver of a vehicle and a user.

Typically, each of the various systems requires separate equipment to operate. For example, the system for tracking vehicles requires a GPS system on board each vehicle and a centralized database system that communicates with the GPS systems to obtain and store location information for each vehicle. Also, a bus may include a communication system such as, a buzzer system or some other alarm system to allow passenger to communicate to a driver when a stop is desired. Further, the base may include a fare collection system that includes a device that reads a card and communicates information from the card to charge a fare to a user account.

As there many separate systems used to perform these various functions, transit operators have a need for a system that can centralize all of the information gathered by these various systems to improve fleet operations and/or customer interactions. As such, there is a need in the art for a centralized system that provides all of the services currently supplied by the various separate systems maintained by a transit operator.

### SUMMARY OF THE INVENTION

The above and other problems are solved and an advance in the art is made by a transportation services platform in accordance with some embodiments of this invention. In accordance with many embodiments of the invention, a transportation services platform communicates with a device on a fleet vehicle and a user device to provide services to users. In accordance with some embodiments, a fare payment system may be provided and provided and/or a destination indication system may be provided.

A system and/or method for providing destination alerts to a user in a fleet vehicle of a transportation provider is provided in the following manner in accordance with some embodiments of the invention. A processing system of a fleet vehicle receives a communication from a user device registering a destination. The processing system in the fleet vehicle determines a boundary limit for the destination and stores the boundary limit and destination associated with the user in a memory. The processing system of a fleet vehicle obtains location information for the vehicle and determines whether location is within boundary limit of destination using the processing system of a fleet vehicle. If the location is within the boundary limit a buzzer system is initiated.

In accordance with some embodiments, the processing system of a fleet vehicle periodically receives the location information. In accordance with a number of embodiments the processing system of a fleet vehicle may also determine whether the location of the fleet vehicle has past the destination using the processing system of a fleet vehicle and disable the buzzer system in response to a determination that the location is past the destination.

In accordance with a number of embodiments, the fleet vehicle includes a manual buzzer system that transmits a signal to the processing system of the fleet vehicle in response to the buzzer system being manually activated. The processing system of the fleet vehicle activates an alert in response to receiving the signal. In accordance with several embodiments, the buzzer system includes circuitry in a housing connecting a device charger coupling to a power supply.

In accordance with some embodiments of the invention, the processing system of the fleet vehicle receives fare payment information from a user device and fare verification information from a transportation services platform system. The processing system of the fleet vehicle verifies the fare payment information from user device with the fare verification information. An indicator on the fleet vehicle is initiated in response to verification of the fare payment information in accordance with a number of embodiments. In accordance with several embodiments the processing system confirms the use of the fare payment information to the user device and/or the transportation service provider platform system. In accordance with some embodiments, the processing transmitting indication of a valid fare in response to a verification of the fare payment information to a driver application on a driver device using the processing system of the fleet vehicle.

In accordance with some of these embodiments, the user device requests a fare amount for a trip from a transportation services platform system and receives the fare amount from the transportation services platform. The user device may then transmit payment information for the fare amount to the transportation services platform and receive the fare payment information from the transportation services platform. The user device may then receive a request for the fare payment information from the processing device in the fleet vehicle and provide the fare payment information to the processing system in the fleet vehicle in response to the request.

In accordance with some embodiments, the user device receives a confirmation of verification of the fare payment information from the processing system in the fleet vehicle. The user device may also transmit the destination of a trip from the user device to the processing system in the fleet vehicle. In accordance with some embodiments, the user device receives a signal that the fleet vehicle is within a determined boundary of the destination and generates an indication that the destination has been reached.

In accordance with some embodiments, a driver device obtains a vehicle identification of the fleet vehicle, a driver identification, and/or location information. The driver device then transmits the vehicle identification, driver identification, and/or location information to the transportation service platform system during a log-in.

In accordance with some embodiments, the driver device periodically obtains an update of the location information using the driver device and provides each update to at least one of the processing system in the fleet vehicle, the transportation services platform system, and a user device. In accordance with a number of embodiments, the processing system in the fleet vehicle receives the updates and compares the destination to the update of location information to the destination. If the location information in the update is proximate the destination, the processing system of the fleet vehicle initiates an alert.

In accordance with some embodiments, a terminal affixes to the fleet vehicle and connects to the processing system in the fleet vehicle. The terminal facilitates communication with a user device via at least one of Near Field Communication (NFC) transmissions, light transmissions, and Radio Frequency (RF) transmission. In accordance with some of these embodiments, the terminal includes a housing that houses an alert system to provide indications of at least one of a valid fare or a destination has been reached.

### BRIEF DESCRIPTION OF THE DRAWINGS

The above and other features and aspects in accordance with various embodiments of the invention are shown in the following drawings:

FIG. 1 illustrating a network communicatively connecting devices that perform the process that provide systems and methods for providing interactions between users and transportation service providers in accordance with an embodiment of this invention;

FIG. 2 illustrating a processing system in one or more of the devices that perform one or more processes for providing systems and/or method systems and methods for providing interactions between users and transportation service providers in accordance with an embodiment of this invention;

FIG. 3 illustrating an operating environment of transportation information system in accordance with an embodiment of this invention;

FIG. 4 illustrating layers of software in a provider platform in accordance with an embodiment of this invention;

FIG. 5 illustrating a display on a user device performing an application interacting with the platform in accordance with an embodiment of this invention;

FIG. 6 illustrating a flow diagram of a process performed by a user device to pay a fare on a transit system in accordance with an embodiment of the invention;

FIG. 7 illustrating a flow diagram of process performed by a user device to transmit fare information to an onboard system in accordance with an embodiment of the invention;

FIG. 8 illustrating a driver device and the display of an application being executed by the driver device in accordance with an embodiment of the invention;

FIG. 9 illustrating a flow diagram of a process performed by an application being executed by a driver/operator device to provide location information for fleet tracking purposes in accordance with an embodiment of the invention;

FIG. 10 illustrating process performed by application being executed by a driver/operator device to verify a user paid a fare in accordance with an embodiment of the invention;

FIG. 11 illustrating a block diagram of devices that are used to provide destination indication and fare validation in accordance with an embodiment of the invention;

FIG. 12 illustrating a timing diagram of a fare validation process in accordance an embodiment of the invention;

FIG. 13 illustrating a timing diagram for a destination indicating process in accordance with an embodiment of the invention;

FIG. 14 illustrating a timing diagram of a fleet tracking process in accordance with an embodiment of the invention;

FIG. 15 illustrating a destination indication terminal for installation on a fleet vehicle in accordance with an embodiment of the invention;

FIG. 16 illustrating a destination indication terminal that communicates with user device to register destination information in accordance with an embodiment of the invention;

FIG. 17 illustrating a fare collection system that communicates with user devices to verify remote payment of a fare in accordance with an embodiment of the invention;

FIG. 18 illustrating a flow diagram of a process performed by a fare verification system for verifying a fare has been paid in accordance with an embodiment of the invention; and

FIG. 19 illustrating a process performed by a destination indicator system to register and indicate a destination to a user in accordance with an embodiment of the invention.

### DETAILED DISCLOSURE OF THE INVENTION

Turning now to the drawings, a transportation service system in accordance with various embodiments of this invention is disclosed. In accordance with some embodiments of this invention, a platform is created in which various transportation providers including, but not limited to, transportation authorities, mass transit operators, and private transportation providers are able to connect and provide web-based services to users. The platform allows transportation providers to develop various cloud-based services that a user may access via the Internet and more particularly via an App being performed by a mobile device. The platform allows the provision of integrated transportation services such that the services and related information are not isolated. This allows for the integration of information from the various transportation providers. The platform simplifies the development of transportation service applications through the development of abstract handlers in the platform with which other applications are able to communicate and be invoked when required.

In accordance with some embodiments, the platform includes a central back-end system that is able to interface with other applications. Further, the central system provides core functionalities of the travel platform including, but not limited to, a trip state machine, a data-turntable that application can use to develop further applications, and fundamental services provided by a mobile device application.

In accordance with some embodiments of the invention, the state based view of a trip divides a trip into a series of segments or states. In accordance with many of these embodiments, predictive modeling algorithms may be provided to detect transitions between states. The predictive modeling algorithms may also determine when to provide alerts and/or messages to the uses when traveling conditions change and effect travel times during a trip in accordance with a number of embodiments. Furthermore, the state based view of a trip allows other applications to interact with a user based upon a current state of a trip. Another application may either obtain information about the trip or invoke an instance of the application based on the state of the trip to allow for a seamless transition between applications providing needed services during a particular leg of a trip. For example, a user may be using a navigation application to get driving directions to a destination and when the car gets to the destination, a parking locator application may detect that the user has arrived at the destination and invoke an instance of the application to help the user find a parking spot near the destination.

In accordance with some embodiments, the platform also provides logic and functionality that allows applications to utilize transit related data. For example, the platform may provide processes that determine an estimated time of arrival at a destination and/or an estimated time of transition to a next leg or state of the trip. These processes may then be used by application developers to provide various features in applications.

In accordance with some embodiments, an application provided by a user device allows a user to interact with the transportation platform. The application includes a unified user interface in accordance with many of the embodiments. The unified user interface is designed to include a universal interface that fits with the workflow of the user and to allow other applications to integrate information and/or links into the interface to allow for additional extensions of the travel experience through the use of other applications provided by third parties. In accordance with many embodiments, the user interface includes three main components: an area map display, a state of trip information display, and dynamic information display. The map area provides a map indicating the locale of the user and may further indicate the route being taken for the trip, and/or points of interest in the local or along the route depending on the particular embodiment. The state information of the trip display may provide information relevant to the current state (or leg) of the trip. For example, the state information may provide information about traffic information, busses scheduled to stop at a particular stop, and/or busses servicing a particular stop. The dynamic information display may alert users to changes in bus schedules, traffic warnings, and/or points of interests along a particular leg of the trip.

In accordance with some embodiments of this invention, the platform provides the ability for different transportation service providers to interact with the platform to use transportation data stored by the platform, provide transportation data to the platform, and/or provide applications or functionalities to a user accessing the platform via an application. This allows the different transportation entities in providing service in a certain area to interact with other providers which in turn leads to a seamless communication with a user accessing the platform via an application performed by a user device.

In accordance with many embodiments of the invention, the platform provides systems for payment of a fare to a user through the mobile device application. In accordance with a number of these embodiments, the platform provides a system and/or process that allow the user mobile device to communicate with a driver device or other system on board a service vehicle to indicate that the fare has been paid when a user boards a transportation service vehicle.

In accordance with a number of embodiments, the platform provides system and processes that allow a user to communicate a destination or stop to a mobile device of the driver or another system on board the transportation vehicle. In accordance with some of these embodiments, power supply system may be provided in place of a conventional buzzer system to allow users to charge a device in transit.

A description of the above and other features and aspects of a transportation platform in accordance with some embodiments of this invention are provided below.

### Network Overview

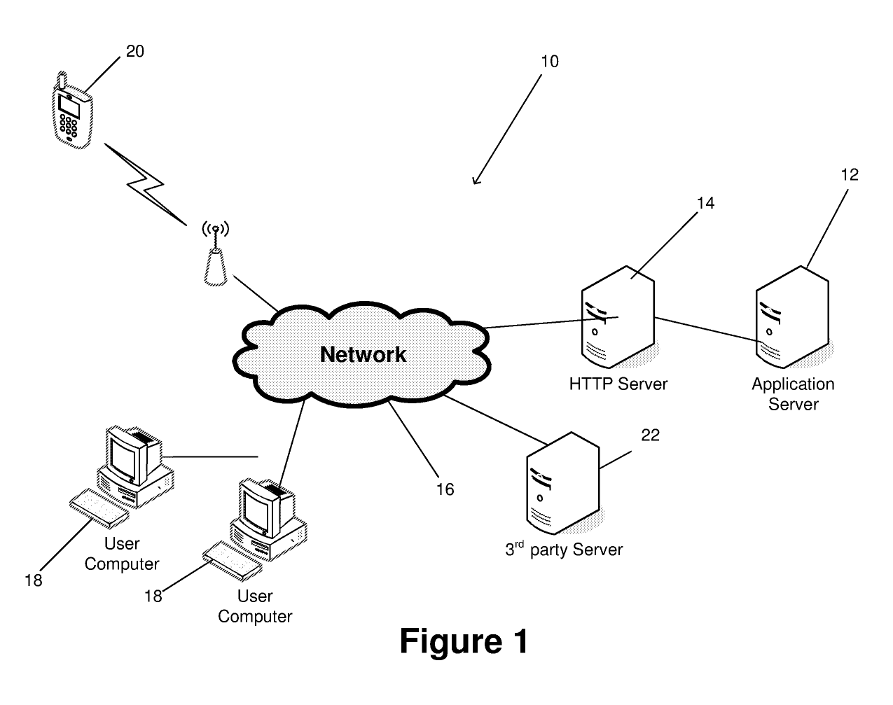

A network that includes processing devices that provide a transportation services platform in accordance with embodiments of this invention is shown FIG. 1. Network 10 includes communications network 16. Communications network 16 is a network such as the Internet that allows devices connected to network 16 to communicate with other connected devices. A platform server system is connected to network 16 and provides a transportation services platform. The platform server system includes servers 12 and 14 that are communicatively connected to one another by an internal network. Servers 12 and 14 perform the processes for providing a transportation services platform and store data associated with the transportation services platform. Those skilled in the art will recognize that while two servers are shown, any number of servers may be included in platform provider system. Furthermore, one or more database servers (not shown) may be communicatively connected to servers 12 and 14 to store data for providing the transportation services platform.

Users interact with the transportation services platform using personal devices 18 and 20 that connect to the platform server system over network 16. In the shown embodiment, personal device 18 is shown as a desktop computer that is connected via a conventional “wired” connection to network 16. However, personal device 18 may be a desktop computer, a laptop computer, a smart television, an entertainment gaming console, automobile infotainment system or any other device that connects to network 16 via a “wired” connection. Mobile device 20 connects to network 16 using a wireless connection. A wireless connection is a connection that uses Radio Frequency (RF) signals, Infrared signals, or any other form of wireless signaling to connect to network 16. In FIG. 1, mobile device 20 is a mobile telephone. However, mobile device 20 may be a mobile phone, Personal Digital Assistant (PDA), a tablet, a smartphone, automobile infotainment system or any other type of device that connects to network 16 via wireless connection without departing from this invention.

### Example of Processing System

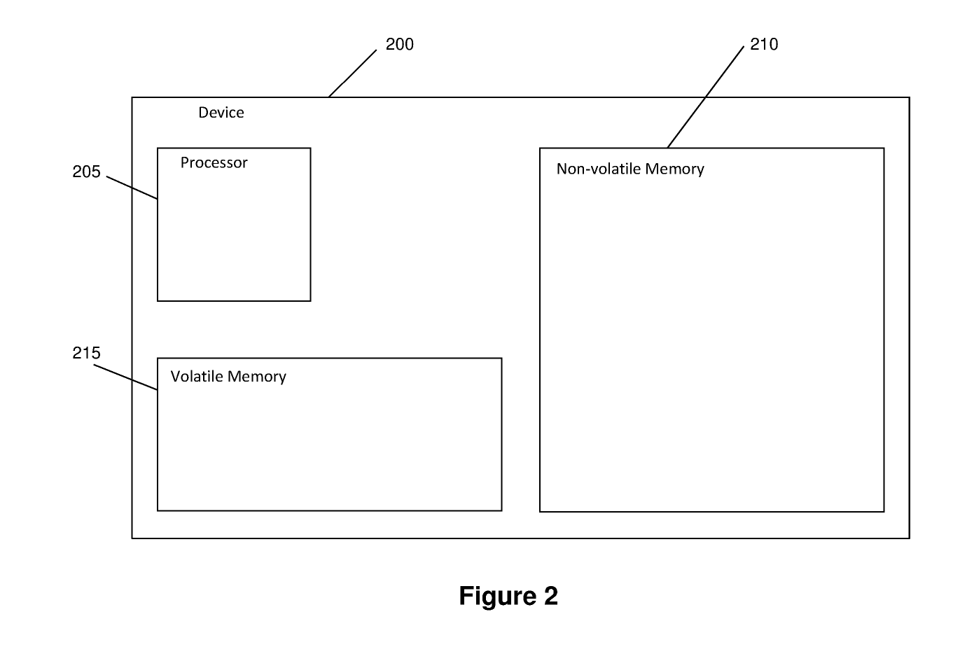

An example of a processing system that executes instructions to perform processes that provide applications, such as the processes that provide and interact with a transportation services platform in the devices shown in FIG. 1 in accordance with embodiments of this invention is shown in FIG. 2. One skilled in the art will recognize that a particular processing system may include other components that are omitted for brevity without departing from this invention. The processing device 200 includes a processor 205, a non-volatile memory 210, and a volatile memory 215. The processor 205 is a processor, microprocessor, controller, or a combination of processors, microprocessor, and/or controllers that performs instructions stored in the volatile 215 or non-volatile memory 210 to manipulate data stored in the memory. The non-volatile memory 210 can store the processor instructions utilized to configure the processing system 200 to perform processes including processes in accordance with embodiments of the invention and/or data for the processes being utilized. In other embodiments, the processing system software and/or firmware can be stored in any of a variety of non-transient computer readable media appropriate to a specific application. A network interface is a device that allows processing system 200 to transmit and receive data over network based upon the instructions performed by processor 205. Although a processing system 200 is illustrated in FIG. 2, any of a variety of processing system in the various devices can configured to provide the methods and systems in accordance with embodiments of the invention can be utilized.

### Transportation Services Platform

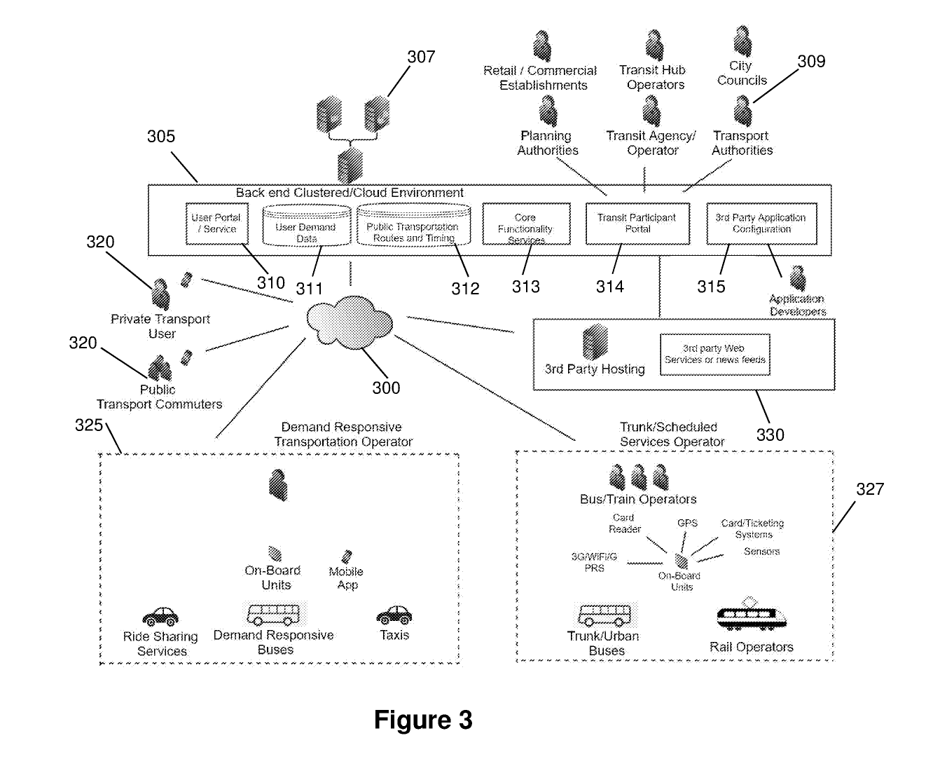

A transportation services platform in accordance with embodiments of this invention is a system that interacts with applications performed on a user device to provide transportation services to a user. The operating environment of a transportation services platform in accordance with an embodiment of this invention is shown in FIG. 3. In the embodiment shown in FIG. 3, server system 307 provides transportation services platform 305. Transportation services platform 305 includes software and/or hardware that provides and a user portal 310, user demand database 311, public transportation routes and timing database 312, core functionality services 313, transportation operator portal 314, and third party application configuration portal 315. The user portal 310 includes the interfaces for interacting with applications on a user device. The user demand database 311 stores user data such as, but not limited to, trips taken, routes used, transportation modes used, time of trips taken, and other information relevant to the transportation uses of a user. The public transportation routes and timing database 312 store information about the routes and stop schedules of transportation vehicles such as, but not limited to, busses and trains. In accordance with some embodiments, the public transportation routes and timing database may include separate databases for each city or particular geographic region supported by platform 305. Core functional services 313 are the processes provided platform 305 that store, retrieve and manipulate data stored in the various databases to provide functions provided to the application on a user device, public transportation operator systems, and/or third party systems. Transit operator portal 314 provides interfaces to transit operator systems 309 for platform 305 to receive data from and provide data to transit operator systems. Third party application portal 315 provides interfaces for third party applications to interact with platform 305.

Platform 305 connects to the Internet 300. Over Internet 300, platform 305 may communicate with user devices of private and public transport users 320; on-board devices including, but not limited to, car infotainment systems, Global Positioning (GPS) systems, navigation systems, and other mobile device in the transportation vehicles 325; transit dispatch and control systems 327 to interact with the users and obtain current transit information; and third party reporting services systems that provide information on local traffic, weather conditions, and other aspects that may affect travel times in a locale.

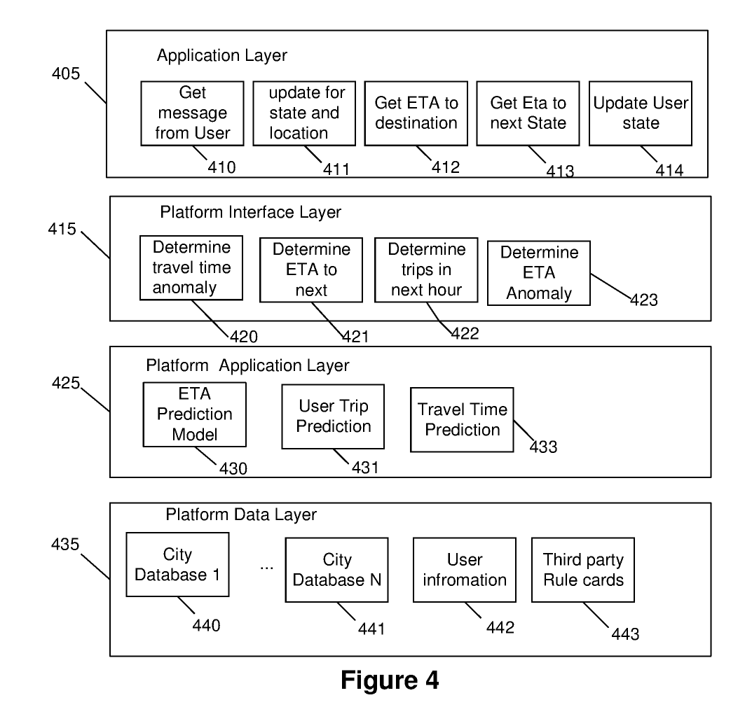

The platform may include various layers of software to provide information to users and/or transit operators. A diagram showing the various layers of software provided by the platform in accordance with an embodiment of the invention is shown in FIG. 4. In accordance with the shown embodiment, the platform includes four layers including application layer 405, platform interface layer 415, platform application layer 425, and platform data layer 435. Application layer 405 includes software that provides functions that may interact with an application being executed by a user device. Examples of the functions that may be provided by application layer 405 include, but are not limited to, get message from user function 410, update for state and location function 411, get ETA to destination function 412, get ETA to next state function 413, and update user state function 414. Get message from user function 410 receives an input from a user via the application executed by the user device. Update for state and location function 411 receives updated location and trip information from applications being executed on user and/or transportation vehicle devices. Get ETA to destination function 412 provides an estimated time of arrival at a desired destination to applications being executed on user and/or transportation vehicle devices. Get ETA to next state function 413 provides an estimated time of arrival at a next leg of a trip to applications being executed on user and/or transportation vehicle devices. Update user state function 414 receives a current state of a trip from an application being executed by a user device. Although the above example primarily involve interactions with an application providing a user interface on a user device, one skilled in the art will recognize that application layer 405 may also include applications for interacting with transit operator systems and third party systems in accordance with various embodiments of the invention.

Platform interface layer 415 includes functions that interact with functions in application layer 405 and platform application layer 425 to transfer information between functions that may be used by an application and functions that obtain and process data stored by the platform in accordance with some embodiments of the invention. Examples of the functions provided by platform interface layer 415 in accordance with the shown embodiment include, but are not limited to, determine travel time anomaly function 420, determine ETA to next location function 421, determine trips in the next hour function 422, and determine ETA anomaly function 423. Determine travel time anomaly function 420 determines whether there are any environmental conditions that may affect the travel time to a particular destination. Determine ETA to next location function 421 determine an estimated time of arrival at next location either a destination or a next leg of a trip. Determine trips in the next hour function 422 provides a list of possible trips a user may take based on pass trips taken by a user. Determine ETA anomaly function 423 is a function that determines whether a previously provided ETA is still accurate based upon current environmental conditions along the route of the trip. Although the above example primarily involve interactions with an application providing a user interface on a user device, one skilled in the art will recognize that platform interface layer 415 may also include applications that obtain data from data stored on the platform for transit operator systems, third party systems, and users in accordance with various embodiments of the invention including, but not limited to, a payment application that allows users to pay for a transportation service via the platform and a social messaging application that allows users to receive and/or send messages pertaining to a particular trip or location.

Platform application layer 425 includes the functions that retrieve and manipulate data stored by the platform to obtain desired information in accordance with some embodiments of the invention. Examples of functions provided by platform application layer 425 in accordance with the shown embodiment include, but are not limited to ETA prediction model 430, User trip prediction model 431 and travel time prediction model 433. ETA prediction model 430 is an artificial intelligence algorithm that learns from the data stored in the platform and uses the learning to predict an estimated time of arrival at a location. User trip prediction model 431 is an artificial intelligence algorithm that learns habits of user regarding trips from user data stored by the platform and returns a list of possible destination for the user based upon environmental conditions. Travel time prediction model 432 is an artificial intelligence algorithm that estimates the travel time between one or more locations based upon the mode of transportation used, time of day, environmental conditions, and/or other factors. Although the above example primarily involve interactions with an application providing a user interface on a user device, one skilled in the art will recognize that platform application layer 425 may also include applications that obtain and manipulate data stored on the platform to obtain desired information for transit operator systems and third party systems in accordance with various embodiments of the invention.

Platform data layer 435 includes the processes and functions for maintaining the data needed to provide the various transportation services in accordance with some embodiments of this invention. Examples of the databases maintained include, but are not limited to, a database for each city or local supported by the city databases 440-441, user information databases 442, and third party rules database 443. Each city database 440-441 includes data regarding routes, stop schedules and the like for public and/or private transportation companies. User information database 442 is a database that stores user information including, but not limited to, profile information, previous trips, transportation mode preferences and the like. Third party rules database stores rules generated for third parties for interacting with application executed by a user device in accordance with some embodiments of the invention.

### User Device Application

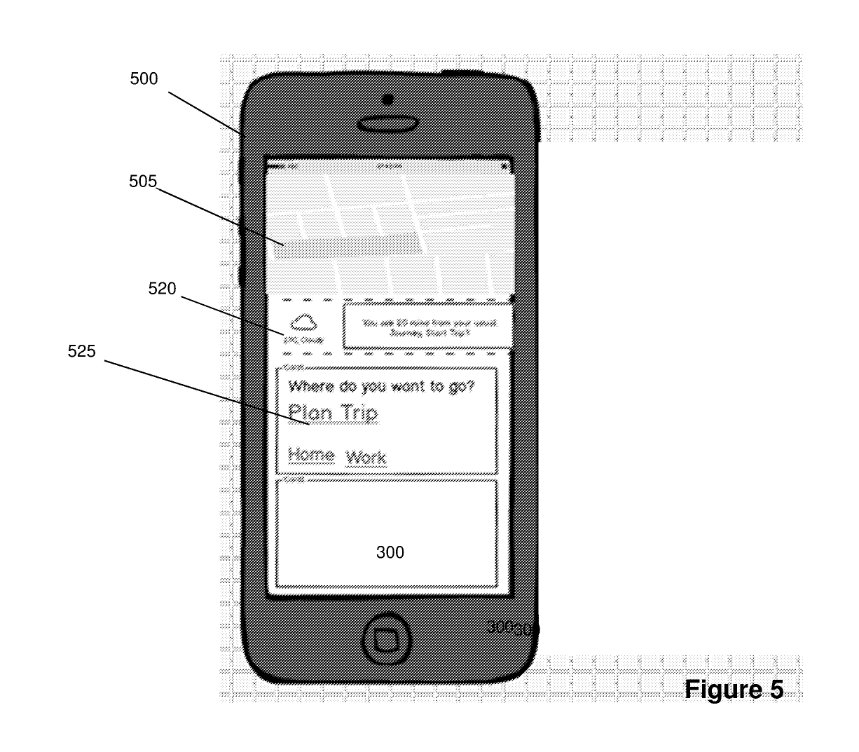

In accordance with some embodiments of the invention, an application for providing transport services to a user is executed by a user device and communicates with a transportation services platform. The application provides a user interface that allows the user to interact with the application to receive a desired transport service. In accordance with some embodiments of the invention, the user interface has a universal design to fit with the individual workflow of a user and allows for “lead-ins” to other applications in order to allow for additional extensions of the travel experience through interacting with other applications. Furthermore, the user interface is provided in a manner that fits with the “state-based” view of a trip used by the platform in accordance with embodiments of the invention. A user interface of an application in accordance with an embodiment of the invention is shown in FIG. 5.

In accordance with FIG. 5, user device 500 is executing the user application that communicates with the platform to provide transport services. The display of device 500 is showing the user interface of the application. The user interface includes three areas: map area 505, travel state information area 520, and dynamic information area 525. Map area 505 is a geographic map or other form of indicia indicating the locale of the user. As those skilled in the art will appreciate, the map area may be interacted with to “zoom-in” and “zoom-out” to change the resolution of the map or locale being shown to the user. Travel state information area 520 provides information relevant to a current state of a trip and changes as the current state of the trip changes. Dynamic information area 525 provides information of third party application to be provided in response to the rules provided by the third party application as well as information provided by the platform that may change as the trip progresses.

The above interface may be one of multiple user interfaces provided the application in accordance with embodiments of the inventions. In accordance with some embodiments, another interface may be provided to allow payment for a transportation service using the platform. In accordance with many embodiments, a user interface may be provided for a social messaging system. In accordance with a number of embodiments, a base user interface is provided that allows a user to select a function supported by the travel services platform and subsequently provide a user interface for the selected function.

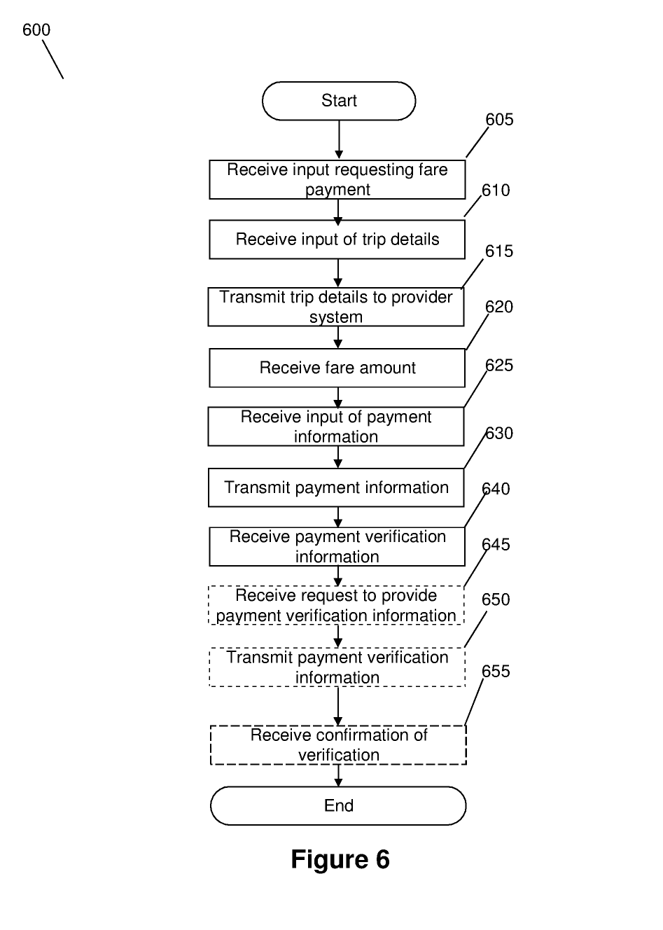

In accordance with some embodiments of this invention, the transport service platform provides a method for user to pay a fare while embarking and/or disembarking a transportation service vehicle. The platform may provide a method for the user device to signal an operator on the public transit vehicle that the fare has been paid. A complete discussion of a system and process for paying fares in accordance with an embodiment of the invention is given below. However, a process performed by a user device to allow a user to pay a fare in accordance with an embodiment of the invention is shown in FIG. 6.

In FIG. 6, a user device performs process 600. Process 600 begins by receiving an input requesting a fare payment (605). In accordance with some embodiments, the input may be the user selecting a button or tab on a user interface. In accordance with some other embodiments, the user may select a link to a particle web site. In accordance with still other embodiment, the input may be the instantiation of a particular Application on the user device. Process 600 also receives details of the planned trip (610). The details may include information that may be necessary to calculate a fare for the trip. In accordance with some embodiments, the details may include at least an embarking location and a destination location.

Process 600 then transmits the trip details to transit platform (615). The transit platform system determines an amount of the fare from the trip details and transmits the amount of the fare to the user device. Process 600 receives the fare amount (620). In accordance with some embodiments, the user device may use the trip details to calculate the fare amount in the device. In which case, the process 600 does not send the trip details to the transit platform.

Process 600 displays the amount of fare and requests an input of payment information. The payment information is received by process 600 (625). In accordance with some embodiments, the user may make a selection of at least one previously stored account using the device interface. In accordance with some other embodiments, the user may input an account number and/or any other information associated with the account. In accordance with many embodiments, the account is a prepaid account. In accordance with a number of embodiments, the accounts may be credit card and/or bank accounts associated with the user.

Process 600 transmits details of the selected account to the transit platform (630). The transit platform credits the selected account for the amount of fare and transmits a verification of payment to the user device. Process 600 in the user device receives the verification (640). In accordance with some embodiments, the verification is receipt for the transaction. In accordance with a number of embodiments, the verification is a token or some other form of encrypted code that may be used to identify that the user has paid the fair to an operator of a transit vehicle.

When the verification is a token or some other encrypted code, process 600 may include the optional steps of receiving a request from a system on-board a transportation service vehicle to provide verification information for the paid fair (645), transmitting the verification information from the on-board system (650), and receiving confirmation of the verification from the on-board system (655). In accordance with some of these embodiments, the receiving of the request to provide the information may be an input by the user using the interface to transmit the verification. In accordance with some other embodiments the requests may be received from the on-board system. In accordance with some of these embodiments, the request may be captured by an I/O device of the user device such as, but not limited to, an NFC transceiver, a camera, and/or RF protocol (such as Bluetooth). In accordance with a number of embodiments, the user device transmits the verification via a network connection by communicating with the transit platform. In accordance with some other embodiments, the process 600 uses I/O devices such as a flash of a camera or an RF antenna to transmit the verification information. In accordance with some embodiments, the user device receives the confirmation of the verification via a network connection by communicating with the transit platform.

Process 600 is one possible embodiment of a process performed by application being executed by a user device to pay a fare for a trip. However, other processes that add, combine, and/or omit certain steps of the above described process may be provided without departing from embodiments of this invention.

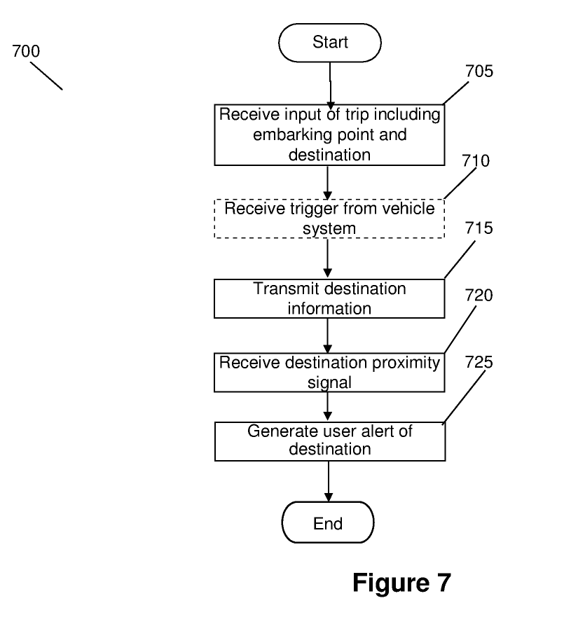

In accordance with some embodiments of the invention, the transit platform may provide systems and/or processes for user to use the user device to provide a destination to the operator of the transit vehicle and/or signal the operator to stop at the destination. In accordance with some of these embodiments, this notification system may replace the buzzer system common on many types of busses and other transportation vehicles. A complete description of a system for the provision and use of destination information by a user in accordance with some embodiments of the invention is give below. However, a process performed by a user device to provide destination information to a system on-board a transportation service vehicle in accordance with an embodiment of the invention is shown in FIG. 7.

In FIG. 7, process 700 receives input of trip information including an embarking location and destination information. In accordance with some of these embodiments, the user types in the embarking and destination locations using the interface. In accordance with some other embodiments, the user uses the interface to select the embarking and destination locations on a displayed map. The received destination information is then transmitted (715). In accordance with some embodiments, the information may be sent to the transportation platform provider system at any time after receipt of the information and forwarded proper system on-board the transportation service vehicle. In accordance with some other embodiments, the destination may be saved in a memory; and process 700 waits to receive a trigger signal from an on-board system (710) and then transmits the destination information to a system on-board the transportation service vehicle (710). In accordance with some of these embodiments, the destination information may be transmitted by an I/O device of the user device such as, but not limited to, an NFC transceiver, a flash of a camera, and/or RF protocol (such as Bluetooth).

As the transportation service vehicle reaches the destination of the user, the process 700 in the user device receives a proximity signal (720). In accordance with some of these embodiments, the proximity may be received by an I/O device of the user device such as, but not limited to, an NFC transceiver, a camera, and/or RF protocol (such as Bluetooth). In accordance with some embodiments, the user device receives the proximity signal via a network connection by communicating with the transit platform. Process 700 then generates a user alert indicating a pending arrival at the destination (725). In accordance with some embodiments, the alert may be a text message and/or email. In accordance with some other embodiments, the alert may be the playback of a sound, a vibration of the user device, or any other alert using another feedback system of the user device. Process 700 then ends.

Process 700 is one possible embodiment of a process performed by application being executed by a user device to provide and use destination information in accordance with some embodiments of the invention. However, other processes that add, combine, and/or omit certain steps of the above described process may be provided without departing from various other embodiments of this invention.

### Operator/Driver Application

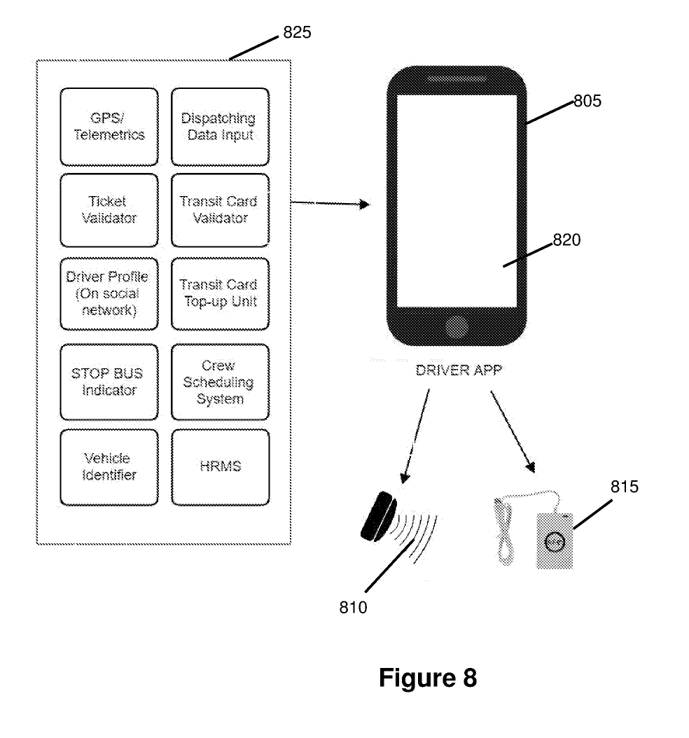

The transport service platform may also interact with a driver/operator application executed by a device on a vehicle of a transportation service provider. Example of driver/operator devices that may execute a driver operator application in accordance with some embodiments of this invention, include, but are not limited, a mobile telephone, a smart phone, a tablet, a vehicle infotainment system, and any other processing system that may be onboard a transportation service provider vehicle. In accordance with some embodiments, the driver operator device includes and/or is connected to devices that provide a GPS system and a card validation system. In accordance with many embodiments, the driver/operator application provides the following services and possibly other services to the driver/operator by interacting with the transport service platform: GPS information, dispatching data input, ticket validation, transit card validation, driver profile information, transit card transactions, stop vehicle indications, crew/driver scheduling information, vehicle identification information, human resource management system (HRMS). A view of a user operator device with an enlarged “screen shot” of a user interface of a driver/operator application in accordance with an embodiments of this invention is shown in FIG. 8.

In FIG. 8, driver/operator device 805 is a smartphone with connections to a GPS device 810 and a card scanning unit 815. An enlarged “screen shot” 1525 from display 820 is shown. The “screen shot” 825 is of a user interface for a driver/operator application being executed by device 805. The user interface includes buttons or tabs that may be touched to perform the shown functions including a GPS/telemetrics function, a dispatching data input function, a ticket validation function, a transit card validator function, a driver profile interaction function, a transit card transaction function, a stop bus indicator function, a crew scheduling information function, vehicle identifier function, and a HRMS function.

Although one specific embodiment of a driver/operator device and user interface for a driver/operator application is shown in FIG. 8. One skilled in the art will recognize that other device may be used and the user interface may provide any number of additional functions without departing from this invention.

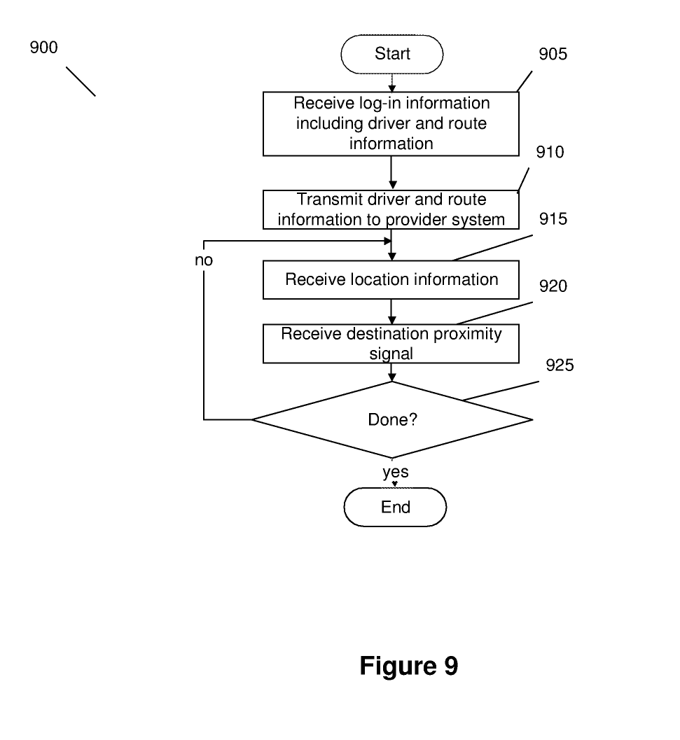

In accordance with some embodiments of the invention, the application being executed on the user device may be used to provide location information to the transit platform system for use in fleet tracking. A process performed by a driver operator device to provide information for fleet tracking purposes in accordance with an embodiment of this invention is shown in FIG. 9.

Process 900 receives an input of log-in information (905). In accordance with some embodiments of the invention, the log-in information includes driver and route information. In accordance with some other embodiments, the log-in information may further include vehicle information. In accordance with some further embodiments, the vehicle information includes a vehicle identification that is received from a system on-board the vehicle during an interrogation process via a wireless connection between the system and driver/operator device.

Process 900 transmits the log-in information to the transit platform system (910). In accordance with some embodiments, the log-in information includes driver and route information. In accordance with some further embodiments, the log-in information also includes a vehicle identification.

Process 900 periodically receives location information (915). In accordance with some embodiments, the location information includes GPS information. In accordance with some of these embodiments, the GPS information is received from a GPS system provided by the driver/operator device. In accordance with some other embodiments, the GPS information is received from an on-board system of the transit service vehicle that includes a GPS system. Process 900 transmits the location information to the transit platform via a network connection (920). Process 900 periodically repeats (925) until a log out command or some other command disables the process.

Process 900 is one possible embodiment of a process performed by application being executed by a driver/operator device to provide location information for fleet tracking purposes in accordance with some embodiments of the invention. However, other processes that add, combine, and/or omit certain steps of the above described process may be provided without departing from various other embodiments of this invention.

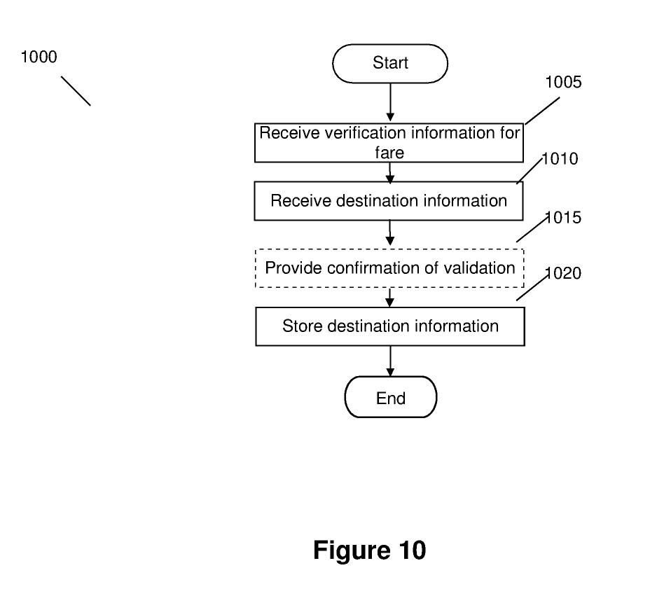

In accordance with some embodiments of this invention, the application being executed on the driver application performs a process for verifying a user has paid a fare. In accordance with some other embodiments, another system on-board a transit service vehicle performs the process. A process performed by application being executed by a driver/operator device to verify a user paid a fare in accordance with an embodiment of the invention is shown in FIG. 10.

Process 1000 receives verification information for a fare (1005) and destination information for a user from a user device. In accordance with some embodiments, the verification information is provided by the user device via a direct communication with the user/operator device. In accordance with some of these embodiments, the connection may be through an NFC device. In accordance with many of these embodiments, the connection may be an RF communication using a Bluetooth or other protocol. In accordance with a number of these embodiments, the communication may be performed using the camera in the driver/operator device and the flash of the camera in the user device. In accordance with still other embodiments, the information is received from the user over a network connection via the transit platform provider system.

In accordance with some embodiments, the verification information is a token or some other form of encrypted information that the driver/operator device decrypts using a key provided by the transit platform to determine the validity of the token or other information. Process 1000 optionally provides a confirmation of a validation of the verification information provided by the user to the user device (1015). In accordance with some other embodiments, the process 1000 uses I/O devices of the driver operator device such as, but not limited to, a flash of a camera or an RF antenna to transmit the verification information. In accordance with some embodiments, the driver/operator device provides the confirmation of the verification via a network connection by communicating with the transit platform. The driver/operator device also stores the destination information for a user in memory (1020) for use in notifying the user upon reaching the destination in accordance with some embodiments of the invention.

Process 1000 is one possible embodiment of a process performed by application being executed by a driver/operator device to provide fare verification in accordance with some embodiments of the invention. However, other processes that add, combine, and/or omit certain steps of the above described process may be provided without departing from various other embodiments of this invention.

### On-Board Systems

### Destination Indicator System

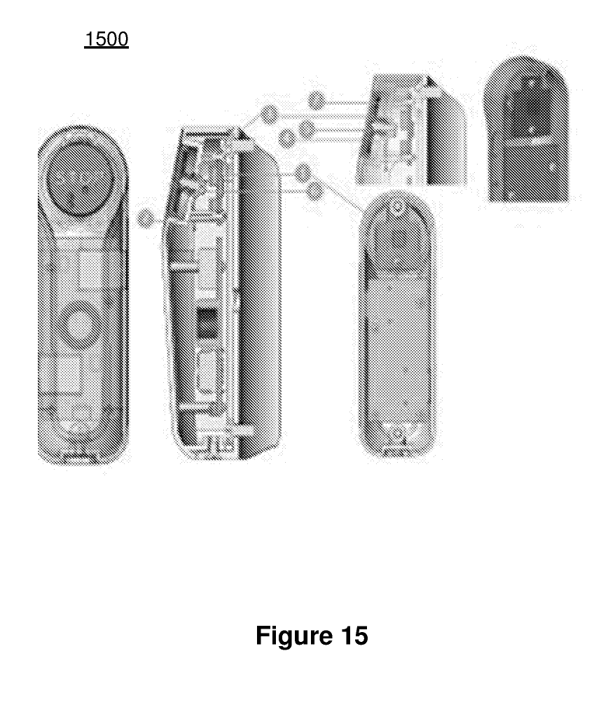

In accordance with some embodiments of an invention, a terminal in a buzzer system that allows a user to indicate when a stop is desired is provided. The terminal is connected to a buzzer, lighted sign, or other type of indicator system that activated in response to a button on the terminal being depressed. As the connection is often electrical, a terminal in accordance with an embodiment of this invention may have a connector, such as a USB connector attached that draws power from the system and allows a user to connect a device to the system for charging. A terminal with a USB connector in accordance with an embodiment of the invention is shown in FIG. 15. Terminal 1500 includes a button (7) that may be depressed to indicate a desired stop and circuitry connected to the button (1) for activating a buzzer system in response to the being depressed. The systems of terminal 1500 are enclosed in a housing that is affixed to the interior of the fleet vehicle in an area accessible by users. The housing also includes at least one USB or other type of connector port and the circuitry (2) that connects to the system for supplying power to the connector.

Although, one embodiment of a terminal having a USB port in accordance with an embodiment of the invention is shown in FIG. 15. One skilled in the art will note that terminals of other shapes, sizes, and having different indicator systems may be made without departing from these embodiments of the invention.

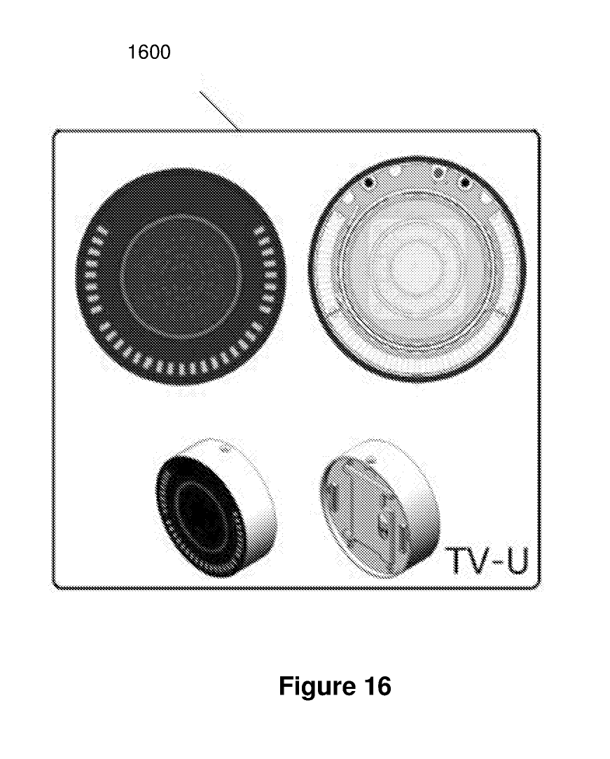

In accordance with some other embodiments of the invention, a destination indicator system communicates with user devices to register destinations of the users and to indicate to each user that their destination has been is approaching and/or has been reached. In accordance with many of these embodiments, the destination indication system is provided by an on-board processing system that may be a stand-alone system or may be part of a vehicle infotainment system. Terminals that allow the destination indication system to communicate with user devices are deployed within the fleet vehicles to facilitate communication between the destination indicator system and the user's devices. A terminal of a destination indicator system in accordance with an embodiment of the invention is shown in FIG. 16. As shown in FIG. 16, terminal 1600 is housed in a compact housing that includes a light display and/or audio out for a buzzer system. The light on the buzzer system may be activated by the destination indicator system when a destination of a user registered with the indicator system is approaching. In accordance with some embodiments, a connector such as, but not limited to, a USB connector may be included in the terminal 1600 to allow users to connect user devices for charging. Furthermore, the terminal may include circuitry to wirelessly communicate with user devices and/or a remote process system providing the destination indicator system in accordance with some embodiments of the invention.

Although, one embodiment of a terminal in a destination indication system that communicates with users devices in accordance with an embodiment of the invention is shown in FIG. 16. One skilled in the art will note that terminals of other shapes, sizes, and having different indicator systems may be made without departing from these embodiments of the invention.

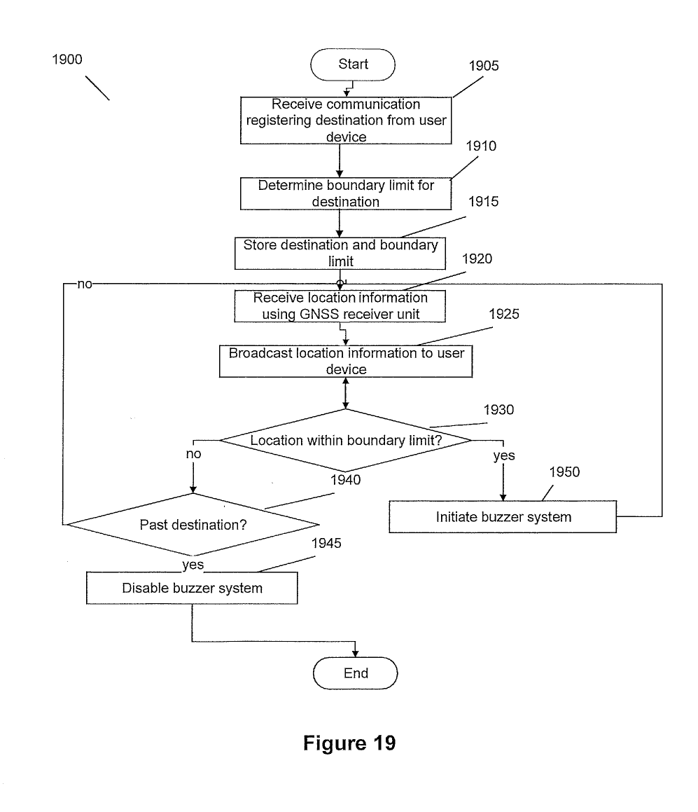

The destination indicator system in accordance with some embodiments of the invention allows users to register a destination with system using the application being executed by their user device. The destination indicator system then monitors the location of the fleet vehicle and signals the user and/or initiates an indicator such as a buzzer or display within the vehicle that the vehicle is approaching and/or has arrived at the destination. A process performed by a destination indicator system by a processing system in an on-board system in accordance with an embodiment of the invention is shown in FIG. 19.

Process 1900 begins be receiving a request to register a destination from a user device (1905). The request is received over the medium being used for communication between a user device and the systems. The mediums that may be used include, but are not limited to, Bluetooth, NFC, network connection via the Internet, and/or via a system such as a display or flash incorporated into the user device. In accordance with some embodiments, the communication includes a destination identifier. In accordance with many embodiments, the request may include a device identifier. In accordance with some other embodiments, the request may include a user identification.

Based on the destination received, the destination indicator system determines boundary limit for the destination (1910). The boundary limit is a proximity area around the destination or along a determined route. The boundary limitation, destination, and an identifier that indicates the associated user and/or user device and a destination identifier in memory.

The destination indicator system periodically receives location information (1920). In accordance with a number of embodiments, the location information is received via a GNSS receiver unit associated with the system and on-board the fleet vehicle. The destination indicator system then provides the location information to the user devices (1925). In accordance with some embodiments, the location information is broadcast by the destination indicator system to all devices registered with the system. A determination is also made as to whether the location is within the limit boundary of the stored destination (1930). One skilled in the art will appreciate that this determination is made for each destination/device currently registered with the system.

If the location is within a boundary limit of a destination, the system initiates a buzzer system and/or transmits a notification to the devices associated with the location within the boundary limit and the process returns to waiting for updated location information (1950). If the location is not within a boundary limit, the system determines whether the vehicle is leaving a destination and disables the buzzer system when a destination is being left (1940) and the process ends for the particular user device. After disabling the system or the vehicle is not leaving a destination, the system returns to waiting for updated location information.

Process 1900 is one possible process for providing a destination indication in accordance with some embodiments of the invention. However, other processes that add, combine, and/or omit certain steps of the above described process may be provided without departing in accordance with various other embodiments of this invention.

### Fare Validation System

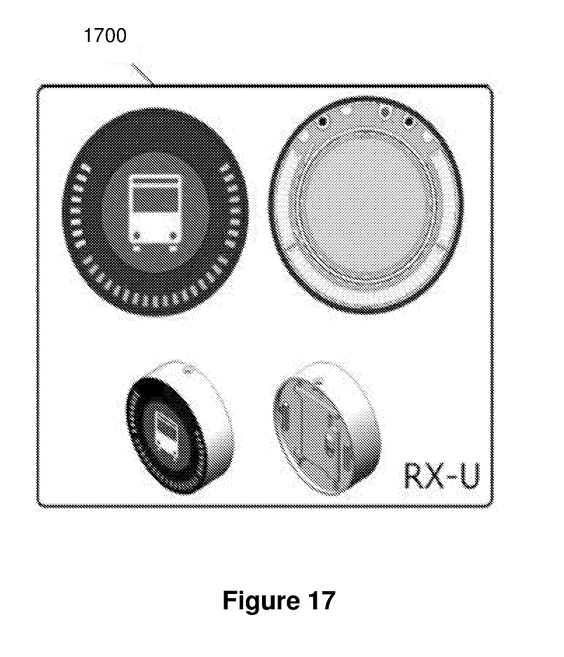

In accordance with some embodiments of the invention, a user may use an application being executed by a user device to pay a fare for a transit service. For a mass transit service such as, but not limited to, a train or a bus, a system is need to indicate to a vehicle operator that the user has paid the fare to use the service. In accordance with some of these embodiments, the user may provide proof that a fare has been paid using the user device. In accordance with some of these embodiments, the user device communicates with a fare validation system that is an on-board system of a fleet vehicle of a transit service provider. One or more terminals of a fare validation may be located throughout a fleet vehicle to provide for communication between the fare validation system and a user device in accordance with some of these embodiments of the invention. A terminal of a fare validation service for placement in a fleet vehicle in accordance with an embodiment of the invention is shown in FIG. 17.

Terminal 1700 has a housing the may be affixed to a surface in the fleet vehicle. The front of the housing has LED's, some other lighting system, or some other alert system that indicates whether a fare is valid or invalid depending on the results of a verification process. The terminal may include an internal power supply such as but not limited to, a battery in accordance with some embodiments or may be connected to a vehicle power supply in accordance with some other embodiments. Further, the terminal may include one or more USB or other type of connects and the related circuitry to allow a user to attach a device for charging.

Although one embodiment of a fare validation terminal is shown in FIG. 17, other terminals that include and/or omit portions of the shown terminal may be implemented without departing from embodiments of this invention.

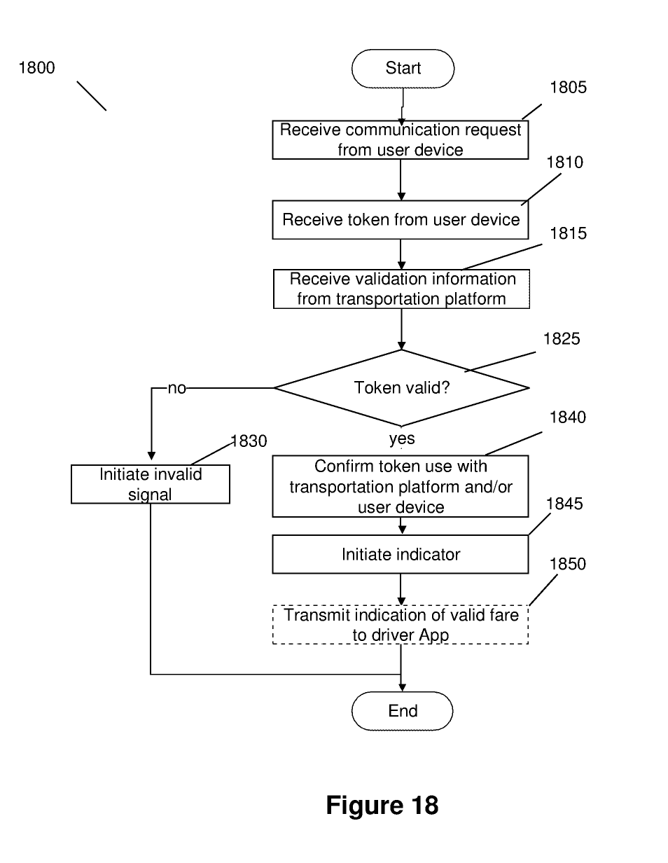

In accordance with some embodiments of the invention, an on-board fare validation system on a fleet vehicle of a transit service provider communicates with a user device to validate a fare paid by the user using an application provided by the user device. A process performed by the fare validation system to validate a fare in accordance with an embodiment of this invention is shown in FIG. 18.

Process 1800 receives a communication request from a user over a communication medium used for communication between the fare validation system and the user device (805). In accordance with some embodiments, the communication mediums may include, but are not limited to, NFC transmissions, light transmission, and/or RF using a specific protocol (such as Bluetooth). The user device transmits a token or some other encrypted information showing the fare payment using the communication medium (1810). The fare validation also receives fare validation information from the transportation platform (815). The fare validation then uses the token and the information from the transportation platform to determine that the token is valid. If the token is not valid, the fare registration system initiates an invalid signal (1830) and may optional send an indication to the user device that the token is invalid and the fare is not paid. If the token is valid, the system confirms that the token has been used to the transportation platform and to the user device (1840). The system also initiates an indicator that displays that the fare is paid (1845). Optionally, the system may also send an indication to a driver application on a driver device to show a valid fare has been collected.

Process 1800 is one possible process for validating a fare has been paid using a user device in accordance with some embodiments of the invention. However, other processes that add, combine, and/or omit certain steps of the above described process may be provided without departing in accordance with various other embodiments of this invention.

### Platform Processes

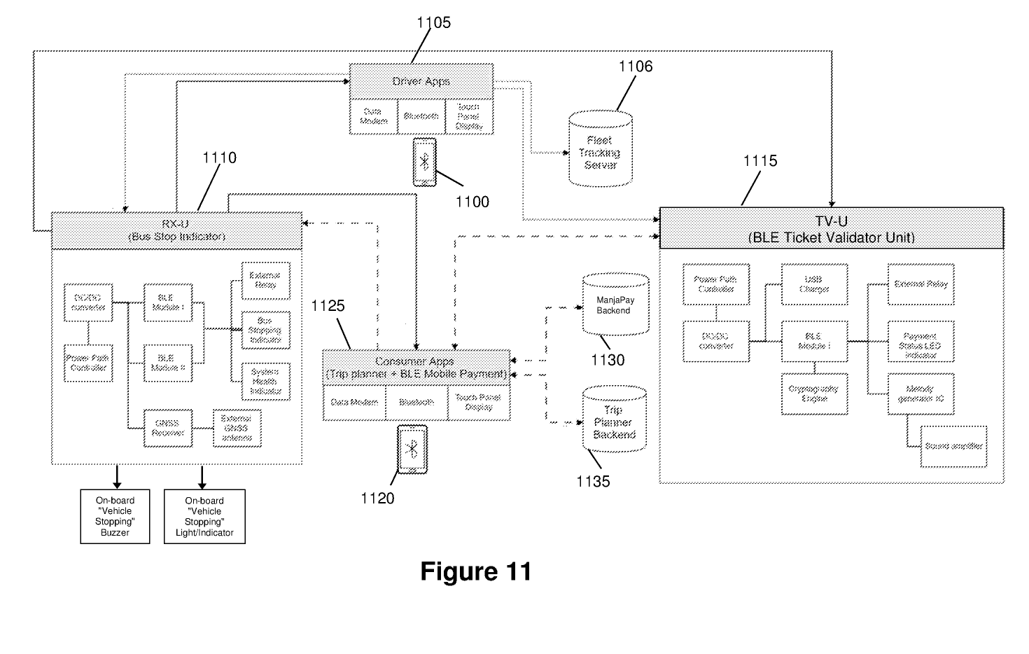

In accordance with some embodiments of the invention, the transit platform provides systems and processes for fare validation and destination indication of a transport service vehicle. A block diagram of devices that are used to provides these systems and processes in accordance with an embodiment of the invention are shown in FIG. 11.

The components used include a driver/operator device 1100; on-board systems 1110, and 1115; and a user device 1120. Driver operator device executes a driver application 1105. The driver/operator device may communicate with a fleet tracking server 1106 over a network connection and the various other components of the system

The on-board systems of the transit service vehicle include a destination indicator system 1110 and fare validation system 1115. The destination indicator system communicates with the applications executing on the driver/operator device 1100 and the user device 1120. The destination indicator system 1110 may also control a stop light and/or buzzer systems for indicating stops in accordance with some embodiments of the invention. The fare validation system 1115 communicates with the applications executing on the driver/operator device 1100 and the user device 1120 to validate that a user has paid a fare for the service.

The user device executes an application that performs the processes of the transit platform in accordance with some embodiments of the invention. The application 1125 communicates with the trip planner application 1135 of the transit platform and a fare collection application 1130 to allow for payment of fares in accordance with various embodiments of the invention.

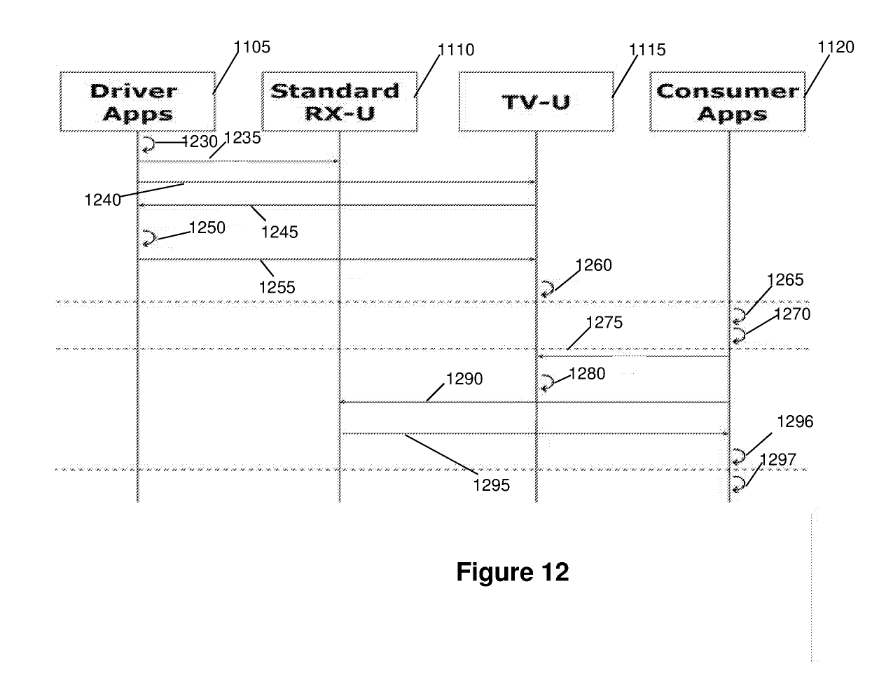

In accordance with some embodiments of the invention, the platform allows a user to pay a fare using the transit platform. To indicate that the user has paid the fare to driver operator a transit service vehicle, the platform must provide systems and process for fare validation. A timing diagram of a fare validation process in accordance an embodiment of the invention is shown in FIG. 12.

The process begins by the using logging into the driver application 1105 being executed on the driver/operator device (1230). Log-in process includes entering a route identification. The driver application 1105 transmits the rout information to the destination indication system 1110 (1235) and to ticket validator system 1115 (1240). The ticket validation system performs and authentication process and provides the driver app a random code and one time password for use in authentication with the transit platform provider system (1245). The driver application then requests a Limited Use Key (LUK) and response code for use in registering with the transit platform system from the transit platform provider system (1250).

The Driver application then sends validation information to the ticket validator system 1115 including the LUK received from the transit platform provider system, the MAC of the driver/operator device, and the one time password (1255). The ticket validator system 1115 then validates the driver application and begins operation (1260).

The user device then uses the user application 1125 to plan a trip (1265) and pay the fare (1270). Upon payment of the fare, the user application 1125 receives a token or some other type of encrypted information indicating the fare is paid. The user application 1125 then uses the I/O devices on the user device to start scanning for a beacon from the transit serve vehicle. When the beacon is received, the user application 1125 send a check-in request including the fare verification information to the ticket validation system 1115 (1275). The ticket validation system 1115 validates the fare using the verification information and activates a signal indicating the fare is paid in response to the validation (1280).

The user application 1125 registers the destination for the trip with the destination indicator system 1110 (1290). The destination indicator system periodically sends outs location update information that is received by the user application 1125 (1295). When the vehicle reaches the destination of the user, the destination indicator system 1110 may optionally send out a destination proximity signal to the user application 1125. The user device then uses the signal strength of this signal or some other means including, but not limited to, sensors on the user device and trip history to determine the user has alighted from the vehicle (1296) and performs a checkout process (1297) that may include recording time and location of the alighting; and requesting any refund of the fare if it is due.

One possible embodiment of a process to provide fare verification and destination indication in accordance with some embodiments of the invention is described by the above timing diagram. However, other processes that add, combine, and/or omit certain steps of the above described process may be provided without departing from various other embodiments of this invention.

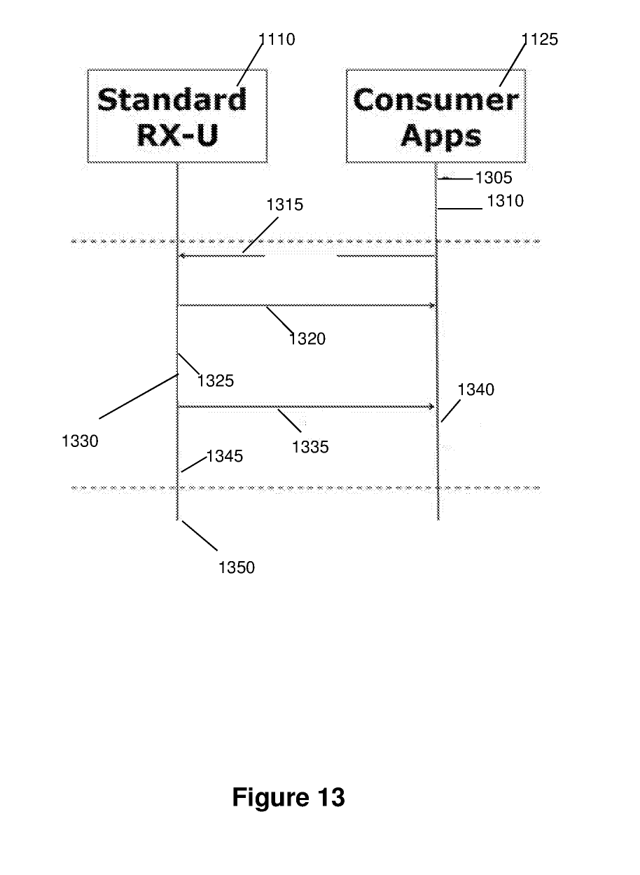

A more detailed timing diagram of a registration and communication process for a destination indication process in accordance with an embodiment of the invention is shown in FIG. 13. In FIG. 13, the user application 1125 begins the process by planning a trip and selecting a trip that includes a point of origin and a destination (1305) using the transit platform system. The user application 1125 then receives an estimated time of arrival of the transit service vehicle (1310). Upon arrival of the vehicle, the user application 1125 registers the destination with the destination indicator system 1110 (1315) and receive an acknowledgement of the registration (1320) from the destination indicator system 1110.

The destination indicator system 1110 then calculates a boundary limit for the registered destination ad stores the boundary limit (1325). The destination indicator system then gets periodic location data updates from a GNSS receiver unit and determines whether the location is within the calculated boundary (1330) and broadcasts location and/or route information to the user application 1125 (1335).

The user application 1125 receives the location information and determines whether the location is near the desired destination (1340). When the vehicle is near the desired destination, the destination indicator system 1110 triggers a bust stopping signal using a connected device such as, but not limited to, a buzzer or display system (1345). When the vehicle leaves the destination, the destination indicator system 1110 disables the signal 1350.

One possible embodiment of a process to provide fare verification in accordance with some embodiments of the invention is described by the above timing diagram. However, other processes that add, combine, and/or omit certain steps of the above described process may be provided without departing from various other embodiments of this invention.

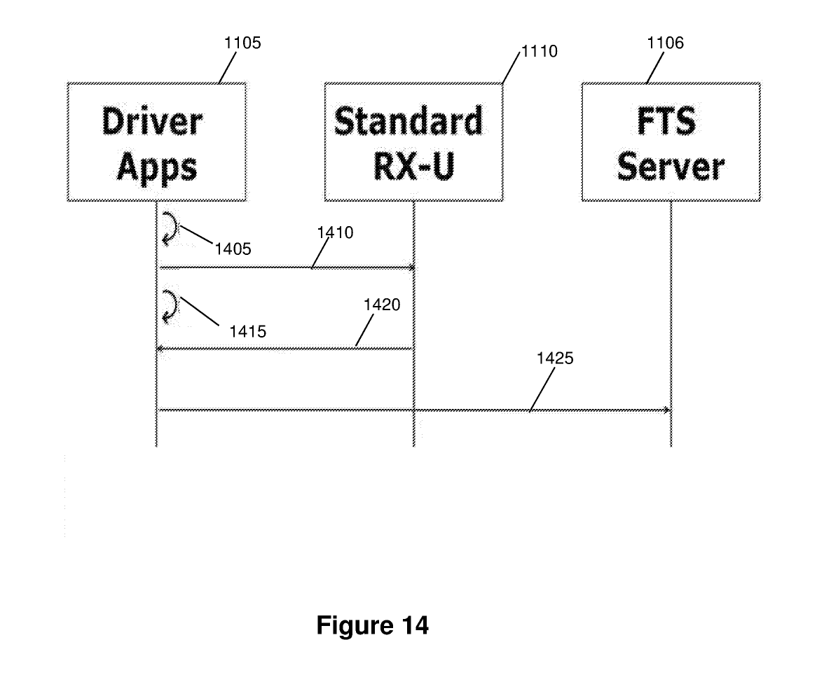

A timing diagram for communications between systems to provide a fleet tracking system in accordance with an embodiment of the invention is shown in FIG. 14.

The process begins with a log-in process performed when the driver/operator opens the driver/operator application on a user/operator device 1105 (1405). The log-in process includes providing a driver identification and a route identification that may be input into the system by the driver/operator. The driver application 1105 then transmits a route registration request to the destination indicator system 1110 (1410). The destination indicator system transmits vehicle identification to the driver/operator application 1105 (1415) and the driver application stores the vehicle identification for later use. During vehicle operation, the destination indicator system 1110 periodically broadcasts a location update (1420). The location update may include a vehicle identification, a route identification, and location data. The driver application receives the location update and generates a vehicle location update that is sent to the fleet tracking server 1106 (1425). This process is repeated until the user performs a logout operation or communication with the driver application 1105 is disrupted.

One possible embodiment of a process to provide vehicle tracking in accordance with some embodiments of the invention is described by the above timing diagram. However, other processes that add, combine, and/or omit certain steps of the above described process may be provided without departing from various other embodiments of this invention.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1-60. (canceled)

61. A system for validating a fare in a transportation services platform comprising: a processing system in a transport vehicle;
a location system that provides a location of the transport vehicle to the processing system;
a buzzer system on the vehicle that is activated in response to a determination from the location system that the vehicle is within a boundary limit of a destination of a user device;
wherein a user device communicates with the processing system of a transport vehicle to provide the destination of the user device and validate that the fare was paid by validating a token provided by the user device.

62. The system of claim 61, wherein the location system periodically updates the location of the transport vehicle to the processing system to show the present location.

63. The system of claim 61, wherein the processing system would disable the buzzer system in response to a determination that the location of the transport vehicle is past the destination of the user device.

64. The system of claim 61, wherein the buzzer system includes a manual button that allows a manual activation of the buzzer system.

65. The system of claim 61, wherein the processing system transmits an indication of a valid fare in response to a successful validation of the fare.

66. The system of claim 65, wherein the indication of the valid fare is transmitted to a driver device.

67. The system of claim 65, wherein the indication of the valid fare requests the user device for confirmation that the fare should be paid.

68. The system of claim 61, wherein the user device receives the amount to be paid for the fare from the transportation services platform based on the destination of the user device.

69. The system of claim 68, wherein the fare is paid using a fare payment information transmitted from the user device to the processing system in the transport vehicle.

70. The system of claim 69, wherein the fare is paid only upon confirmation by the user device that the fare should be paid.

71. The system of claim 61, wherein a signal that the transport vehicle is within a determined boundary of the destination is received by the user device and an alert is generated by the user device to indicate that the destination of the user device has been reached.

72. The system of claim 61, further comprising a driver device that is able to obtain and display update the location of the transport vehicle to the transportation services platform.

73. The system of claim 61, wherein the processing system in the transport vehicle is in communication with the user device to transmit an alert to the user device when the transport vehicle is within a determined boundary of the destination of the user device.

74. The system of claim 61, further comprising a terminal in the transport vehicle that is connected to the processing system and facilitates communication between the processing system and the user device via one of Near Field Communication (NFC) transmissions, light transmissions, and Radio Frequency (RF) transmission.

75. The system of claim 61, further comprising an alert system to provide an indication that the transport vehicle is within a determined boundary of the destination of the user device.

76. A method for validating a fare in a transportation services platform on a fleet vehicle comprising:
receiving a communication request from a user device;
receiving a token from the user device;
validating the token based on information stored within the transportation services platform;
confirming use of the token with the user device; and
providing an indicator that the token is valid,
wherein the indicator is provided to a driver device.

77. The method of claim 76, further comprising:
determining a boundary limit for the destination of the user device,
storing the boundary limit and the destination of the user device in the memory of the transportation services platform;
obtaining a location of the fleet vehicle;
determining that the location of the fleet vehicle is within the boundary limit; and
initiating a buzzer system on the fleet vehicle when the location of the fleet vehicle is within the boundary limit.

78. The method of claim 77, further comprising receiving the location of the fleet vehicle periodically.

79. The method of claim 78, further comprising determining whether the location of the fleet vehicle is past the destination of the user device; and disabling the buzzer system in response.

80. The method of claim 77, further comprising transmitting a signal from the buzzer system in response to the buzzer system being activated and activating an alert in response to the signal.

81. The method of claim 77, further comprising confirming payment of the fare by the user device.

82. The method of claim 81, wherein the payment of the fare by the user device is done by transmitting a fare payment information from the user device.

83. The method of claim 76, further comprising:
transmitting an amount to be paid for the fare to the user device based on the destination of the user device; and
receiving the amount to be paid for the fare from the user device.

84. The method of claim 83, wherein the amount to be paid for the fare from the user device is by receiving a fare payment information from the user device.

85. The method of claim 83, further comprising transmitting an acknowledgment of the confirmation of payment of a fare to the user device.

86. The method of claim 76, further comprising: receiving a signal that the fleet vehicle is within a determined boundary of the destination of the user device and generating an alert on the user device.

87. The method of claim 76, further comprising
obtaining a vehicle identification of the fleet vehicle from a driver device;
obtaining a driver identification from the driver device;
obtaining a location information from the driver device; and
transmitting the vehicle identification, driver identification, and location information from the driver device to the transportation services platform system.

88. The method of claim 87, further comprising periodically obtaining an update of the location information from the driver device; and providing an update from the driver device to at least one of the transportation services platform and the user device.

89. The method of claim 76, wherein the transportation services platform includes a processing system in the fleet vehicle.

90. The method of claim 77, further comprising providing a terminal in the fleet vehicle that communication with the user device via one of Near Field Communication (NFC) transmissions, light transmissions, and Radio Frequency (RF) transmission.
